(19) United States
(12) Patent Application Publication
(10) Pub. No.: US 2008/0069985 A1
(43) Pub. Date: Mar. 20, 2008

(54) Tubular Food Casing Having Glued, Permanently Elastic Longitudinal Seam

(76) Inventors: Michael SEELGEN, Idstein (DE); Holger Schlange, Wulsbuettel-Hoope (DE)

Correspondence Address: PROPAT, L.L.C., 425-C SOUTH SHARON AMITY ROAD, CHARLOTTE, NC, 28211-2841, US

(21) Appl. No.: 11/767,628

(22) Filed: Jun. 25, 2007

(30) Foreign Application Priority Data
Jun. 27, 2006 (DE) 10 2006 029 401.7

(51) Int. Cl. B29D 23/00; B05D 3/12

(52) U.S. Cl. 428/34.3; 427/289; 428/34.8

(57) ABSTRACT

A description is given of a tubular food casing having a glued, permanently elastic longitudinal seam based on a flat fibrous material coated with acrylic, collagen and/or a protein derived therefrom. The seam is generated using a reactive hotmelt glue. The glued seam is resistant to boiling for a long time and also exhibits sufficient stability thereafter. The insert is preferably a textile material, a concolidated nonwoven or spunbonded nonwoven, a woven fabric, loop-forming knitted fabric, laid fabric, loop-drawingly knitted fabric or a fiber paper. It is coated in the flat state. The coated longitudinal strip is cut into strips according to the diameter of the casing to be produced and glued using a PUR hotmelt glue to form the tube. The food casing is preferably used as artificial sausage casing or for wrapping cheese or fish.

This Application claims priority to its parent, German Patent Application No. 10 2006 029 401.7, filed Jun. 27, 2006, which is incorporated herein by reference in its entirety.

### BACKGROUND OF THE INVENTION

1. Field of the Invention

The invention relates to a tabular food casing having internal reinforcement and a glued longitudinal seam, a process for production thereof and also use thereof as artificial sausage casing.

2. Description of the Related Art

Tubular sausage casings based on regenerated cellulose having an internal reinforcement of fiber paper, in particular of hemp fiber paper, have long been known (see G. Effenberger, Wursthüllen—Kunstdarm [Sausage casings—artificial skin], 3^{th} edition [2006] Deutscher Fachverlag GmbH, Frankfurt a.M., pp. 47-55). These casings, generally termed cellulose fiber skins are generally produced by the viscose process. In this process first a fiber paper is formed to give a tube having overlapping longitudinal edges which is charged with viscose from the outside, from the inside or from both sides using a ring die. The viscose is then regenerated to cellulose hydrate in a precipitation bath.

Cellulose fiber skins may also be produced by the newer amine oxide process. In this process the cellulose is dissolved in aqueous amine oxide, preferably in N-methylmorpholine N-oxide monohydrate. This solution is applied to the fiber paper formed to give a tube. The cellulose is then precipitated in a bath which contains a dilute aqueous amine oxide solution. In this manner a seamless easing may be obtained, as in the viscose process. In contrast to the viscose process, the cellulose in the amine oxide process is not chemically derivatized, but is purely physically dissolved. After sniffing with sausage emulsion, cellulose fiber skins are substantially transparent.

However, all of these processes have the disadvantage that they are highly cost intensive. In addition, the diameter of the casing, that is to say the “caliber”, is predetermined by the diameter of the ring gap of the ring die, in such a manner that, on a plant, only one caliber can be produced in each case per die used. A change to a different caliber is therefore associated each time with an alteration and corresponding down time of the plant.

In addition, acrylic-coated textile skins (DH-A 31 47 519 and DE-A 37 04 563) are also known. The textile base material used therein can be a consolidated nonwoven, a spunbonded nonwoven or a woven fabric made of natural fibers and/or artificial fibers. Fibers which are mentioned are those of cotton, linen, wool, silk, cellulose esters, regenerated cellulose, polyester, polyamide, polyacrylonitrile, polypropylene and poly(vinyl chloride). The base material is coated with an acrylic emulsion polymer based on lipophilic esters of (meth)acrylic acid with lower alkanols, in particular butyl acrylate. The coating is applied using conventional coating devices, such as an air knife, roll doctor or rubber cloth doctor, in a direct process or in the transfer process. Subsequently the coated strip is formed to give a tube and the seam is closed by gluing, stitching, sealing or welding. By an appropriate choice of the coating, the acrylic-coated textile skin can he made water vapor-permeable and gas-permeable and it is smokeable, so that it is also suitable for long-life sausage.

In DE 10 2005 056 574 which was unpublished at the priority date of the present application, a food casing made of a flat fibrous material coated on one or both sides with acrylic resin is disclosed. The casing can also be tubular and have a glued longitudinal seam as shown in the examples. The seam in this case is generated using a hotmelt glue. There are no further details on the type of hotmelt glue.

However, these casings have some disadvantages. Firstly incomplete coatings owing to lack of adhesion of the acrylic used constantly occur. In addition, a casing has different properties in the region of the longitudinal seam produced by a polyamide hotmelt than in the remaining regions, in particular different elasticity, extensibility and smoke permeability. In addition the strength of the longitudinal seam frequently weakens under the action of hot water, as is customary in use of the casing for scalded-emulsion or cooked meat sausages. In general, casings having glued seams based on conventional hotmelts have insufficient strength for the increased requirements of modern industrial sausage manufacture, for example automated boiling lines, so that here increased amounts of rejects occur which, in particular, are caused by bursting of the seam.

### SUMMARY OF THE INVENTION

The object was therefore to develop a food casing which no longer has the described disadvantages, or has them only to a very much lower extent. In particular, the advantages of the flat coating shall be utilized, and also optical and haptic properties of the textile skin shall he combined with extensibility and elasticity of the cellulose skin which are approximately uniform over the periphery. The surface, depending on requirements, shall be adjustable from matt to glossy. Its properties, especially its water vapor and oxygen barrier properties and also smoke permeability shall be very similar to those of the textile skin, but considerably more uniform. The very good mechanical properties of the textile support material shall be further utilized and the longitudinal seam shall withstand the increased requirements of modern industrial sausage manufacture.

All these objects may he achieved using a fiber-reinforced casing, the longitudinal seam of which is generated by a reactive hotmelt glue.

### DETAILED DESCRIPTION OF THE INVENTION

The present invention therefore relates to a tubular food casing made of a coated flat fibrous material having a glued longitudinal seam wherein the seam is generated by a reactive hotmelt glue.

The reactive hotmelt glue is preferably a hotmelt glue curing under the action of moisture, preferably a polyurethane-based one-component hotmelt glue. This has a multiplicity of side position isncyanate groups which, in the presence of water, react intermolecularly and/or intramolecularly with urethane groups of the polyurethane, forming urea bridges.

In a preferred form, for the production of a glued seam, use is made of a reactive polyurethane-based hotmelt (hereinafter also termed “PUR hotmelt”). Compared with the polyamide glues used in DE-A 37 04 563, they have the advantage that they lead to a permanently elastic, absolutely shir-stable, UV-resistant seam. The coefficents of elasticity of coated support material and the support material which is additionally charged with glue are virtually identical in this case. Particular preference is given in this case to reactive PUR hotmelt glue having a Brookfield viscosity of 3000 to 7000 mPa·s, preferably from 4000to 6000 mPa·s, particularly preferably about 5000 mPa·s, in each case measured using an RVT DVT-II digital viscosimeter, spindle 27. If the viscosity is below 3000 mPa·s, then the glue penetrates too greatly into the fibrous material. If, in contrast, it is above 7000 mPa·s it can only be processed with difficulty. The softening temperature of the reactive PUR hotmelt glue is generally below 160° C., preferably in the range from 90 to 130° C. Such reactive PUR hotmelt glues are described, for example, in WO 2005/033242. In addition to polyurethane-based hotmelts, use can also be generally made of those based on polyester or polyamide. These hotmelt glues have a higher softening temperature. Generally, the softening temperature is below 260° C. The glue generally does not contain particles.

The food casing of the invention therefore has a permanently elastic, boiling-resistant and simultaneously mechanically loadable seam. In contrast to casings whose longitudinal seam was generated using conventional glues, they can be shirred without problem. The seams are not only boiling-resistant, but also shear-stable, very resistant to fatty acids and are in addition smoke permeable. The food casing of the invention in addition has the advantage that the glued seam has a very high elasticity with simultaneous strength.

Commercially conventional textile fibrous materials are pretreated with a sizing material, usually based on starch, modified starch or lubricating reagents. In addition, preservative reagents can also be present in the finish. Since the means used according to the prior art can considerably interfere with the application of acrylic resin and its incorporation into the textile matrix, it must be desized in advance. Sizing materials have also provided interfering which dissolve in aqueous coating dispersions and can accumulate. These are, for example, those based on starch or modified starch, mixtures of water-soluble starch and poly(vinyl alcohol), in addition also lubricating agents and lipids. It is assumed that sizing materials are likewise the essential cause of the spots which occurred in the food casing according to DE-A 38 26 616.

Interfering sizing materials or else interfering, preservatives can be removed, for example, by washing or enzymatic treatment. After removal of the sizing material, the textile support material frequently exhibits decreased mechanical stability. By an impregnation of the carrier material, the required mechanical stability can be reachieved. Suitable sizing materials could remain in the textile material.

Surprisingly, it has been found that as a result of the prior desizing of the textile, not only does the tightness of the coated casing increase, but also the seam strength increases considerably. The casing of the invention is therefore also suitable for industrial processes for producing cooked-meat sausages or scalded-emulsion sausages. In the region of the seam it virtually no longer bursts.

The flat textile material is preferably a woven fabric made of natural fibers. Preferred materials are cotton, regenerated cellulose (viscose staple), linen, wool or silk. Mixtures of these various materials may also be used, for example mixtures of viscose staple and cotton.

In further embodiments, the insert is a loop-formingly knitted fabric, loop-drawingly knitted fabric, laid fabric, consolidated nonwoven or spunbonded nonwoven made of natural fibers, synthetic fibers or mixtures thereof. These can, in addition, comprise polyester, polyamide, polyolefin. (in particular polypropylene), poly(vinyl acetate), polyacrylonitrile, poly(vinyl chloride) and also the corresponding copolymers. These various materials may also be used as mixtures (for example mixtures of cotton and polyester). Particular preference is given to a thin woven fabric, stretched in the longitudinal and transverse direction, made of cotton, viscose staple or a mixture of cotton and polyester, cotton and viscose staple or viscose staple and polyester. The flat insert can also be a fiber paper, in particular a hemp fiber paper.

The expression “flat” is to be taken to mean materials which are relatively thin, but are selfsupporting. Thickness and weight per unit area are also dependent on the later use of the casing. In general the weight per unit area is 8 to 300 g/m², preferably 20 to 200 g/m², particularly preferably 25 to 120 g/m². Fiber papers preferably have a weight of about 15 to 29 g/m²i, particularly preferably 1.9 to 25 g/m².

Depending on requirements, the support material is extensible or virtually inextensible. Inextensible flat inserts are logical for casings in which a particularly high caliber constancy is of importance.

In an alternative embodiment, the textile support material, after desizing, is preheated in such a manner that it can participate in a particularly strong bonding to the coating material, which is preferably an acrylic resin. Suitable materials are, in particular, those which have a chemical constitution similar to or approaching the coating material, particularly highly dilute aqueous dispersions of the actual coating material. It is necessary to pay attention here to else feet that only small amounts are used and not all interstices between the fibers are filled, in order not to impair the adhesion of the coating material during the actual coming.

Subsequently the textile, for the purpose of stiffening or to achieve optical properties, can be finished again on one or both sides for the coating. Particularly suitable compounds here are melamine-formaldehyde resins, hydroxypropylated starch ethers, other wet strengthening agents and finishes, acetates (for example vinyl acetate/maleic acid di-n-butyl ester), acrylic resins and plastic blends, especially emulsion polymers based on (C-C₆)alkyl (meth)acrylates, in particular butyl (meth)acrylate. The expression (meth)acrylate in this case, as is customary, means acrylate and/or methacrylate. Units of other monomers can occur, for example those of styrene, α-methylstyrene, vinyl acetate/maleic acid di-n-butyl ester or vinyl acetate. The fraction of the units of such other monomers should not exceed 25% by weight, preferably 15% by weight. Suitable acrylic resins are known to those skilled in the art, in particular from DE-A 31 47 519. Not only the denizing but also the finishing, for example by means of foularding (=immersion coating) are sufficiently known to a textile specialist.

The materials used for the pretreatment can be colored by dyes and/or color pigments. In addition, the insert can also he impregnated on one or both sides. By means of such an impregnations, for example, the sausage emulsion adhesion can be set or the mold resistance increased. Impregnation can also comprise transferable color, aroma, odor and/or taste components (for example liquid smoke). However, they can also be applied later to the coated flat material or the tubular casing formed therefrom. These components are expediently used only in a small amount.

In a further embodiment, the support material can be colored using color pigments and/or pigments, during the pretreatment. In the following step, the dyed support material is then preferably coated with colorless acrylic. Likewise, the flat material can be provided with large-area printing or pattern printing.

After completion of pretreatment, the preferably colorless insert can be equally coated on one or both sides, preferably with silicone-free acrylic resin. The coating proceeds particularly advantageously in a plurality of process steps, particularly preferably in 2 or 3 process steps, with intermediate drying in each case. Addition of dyes and/or pigments to the acrylic can likewise color the casing. For the coating, in addition to acrylic resins, use can also be made of collagen and/or proteins derived therefrom, for example desamidocollagen. However, it is also possible to apply the coating, in particular a coating with acrylic resin, indirectly in a transfer process.

The casing can if appropriate additionally receive aroma substances, taste substances or odor substances which can be transferred to the sausage emulsion. Those which may be mentioned here are, in particular, dry smoke or liquid smoke. Preferably, the casing contains an impregnation, to set the sausage emulsion adhesion. The oxygen permeability and water vapor permeability of the casing of the invention is adjustable.

An additional PVDC layer gives the casing a particularly high water vapor and oxygen barrier property, thus preventing drying out of the sausage and coloring of the sausage emulsion by oxidation. This is particularly of importance in the case of air-sensitive sausage emulsion types such as Leberwurst.

The casing generally has a water content of about 2 to 70% by weight, preferably from about 4 to 10% by weight. In this case it is of importance not to complete directly the condensation of the polymer coating.

Surprisingly, it has been, found that the bonding of flat fibrous material and coating becomes considerably better when a terminating condensation does not take place until on the roll. Between production of the coated broad rolls and the subsequent processing steps (cutting and gluing) there are then at least 2 to 30 days, preferably 15 to 25 days. This also leads to a still further improved seam strength.

The food casing of the invention has a wafer vapor permeability (as specified in ISO 15106) of 2 to 2000 g/m²·d, preferably 5 to 1500 g/m²·d. Its oxygen permeability is generally 100 to 1000 cm²/m²·d (determined as specified in ISO 7783-2 at 53% relative humidity), measured b a 5 cm² size piece of the casing having a water content of 8 to 10% by weight and a plasticizer content of about 15% by weight.

Customarily, the casing is smoke permeable, but cars also be smoke impermeable with a corresponding coating. The extension behavior of the casing is determined by the type and thickness of the coating, but also by the type and strength of the flat fibrous material. For instance, the total extension fraction (elastic and plastic extension) can vary between 1 and 20%, preferably the elastic extension traction is between 2 and 6%.

Processes and devices for production of the casing of the invention are known per se to those skilled in the art (see G. Effenberger, Wursthüllen—Kunstdarin [Sausage casings—artificial skin], 3^{rd} edition [2006] Deulscher Fachvelag GmbH, Frankfurt/Main, pp., 71/72).

The flat support material is preferably coated, in this case repeatedly with acrylic resin by a flat coating process. The coating is then dried and should in addition condense or core for some time. Suitable processes and devices therefor are known to those skilled in the art. In a further step, if appropriate, a last coating stroke with PVDC or a VDC copolymer can be performed. After drying, a material thus coated is scarcely permeable to water vapor and atmospheric oxygen, and can therefore be used for what are termed “barrier casings”. Thereafter, the coated flat material can he cut into individual strips. If desired, if can be printed before or after cutting, expediently in a flexo printing process. The individual strips are then brought via a forming shoulder into a tubular form having overlapping longitudinal edges of 2 to 14 mm, preferably 6 to 12 mm, and the overlapping is then fixed using a reactive hotmelt glue. In this case gluing is preferably carried out in such a manner that no projecting “Hash” remains. This has the further advantage that bacteria or other microorganisms can virtually no longer penetrate through the seam region.

It has been found that it is of importance for the quality of the glued seam that the reactive hotmelt glue used, after melting, is not simply applied in stick form, but rather a defined thin film of the melt is applied to the upper side of the first longitudinal seam. Only then, after joining the two longitudinal sides does a uniform glued film develop. In the case of the customary stick application, in contrast, this gives a non uniformly contoured glued surface which frequently runs out of the seam area on one side and then leads to sticking of the roll material together. Also the seam strength suffers under the nonuniform glued surface.

Furthermore, it has been found that the glued seam produced with the reactive hotmelt glue increases in strength when it is stored under defined conditions. Particularly expediently, the glued “raw tube” is allowed to react to completion at 25 to 75% relative humidity and 20 to 45° C. for 3 to 7 days, particularly preferably at about 50% relative humidity and about 35° C. for about 7 days. It is of critical importance here that the amount of water required for curing is already introduced during the tube forming and the moisture of the ambient air during curing only counteracts diffusion from the glued raw tube.

In a particular embodiment tubes may thus be produced with any desired shapes, preferably with irregularly contoured edges. The resultant casings may likewise be used as food casings, in particular as artificial sausage casings having natural skin optical appearance for more demanding applications.

The casing of the invention may be stuffed with pasty to slightly creamy foods, in particular with sausage emulsion, using conventional stuffing machines. When his used as sausage casing, it is expediently used in shirred form (as what is termed a shirred stick) or in the form of individual sections. The individual sections in this case are closed at one end, for example by a metal or plastic clip, by tying off with yarn, by knotting, gluing, sealing or welding or stitching (with the seam or the casing or the casing section being able to be formed straight, curved, or in a special way). The sections are pushed individually onto the stuffing horn of the stuffing machine, stuffed with sausage emulsion and closed. Further processing can proceed as customary by scalding, boiling, smoking, ripening etc.

Part of the present invention is therefore also the use of the inventive casing as artificial sausage casing, in particular for raw sausage, scalded-emulsion sausage, or cooked-meat sausage, or as wrapping for cheese or fish.

If desired, the tubular food casing of the invention can be covered with a net which comprises, for example, honeycomb-shaped, octagonal, square or rectangular structures. The net, if appropriate, is also elastic.

The examples hereinafter are intended to illustrate the invention. Percentages therein are percentages by weight, unless stated otherwise or is clear from the context.

### EXAMPLE 1

A woven fabric of 100% viscose staple having a weight per unit area of 58 g/m² was enzymatically desired and coated with colorless acrylic resin by doctorknife application. After drying and condensation, the textile thus coated had a total weight of 92 g/m². The open-width product was cut into strips having a width of 152 mm which were then formed via a forming shoulder to give tubes. The 8 mm overlapping longitudinal edges were glued using a reactive PUR hotmelt glue. The casing was tied off and staffed with salami emulsion. After a ripening time of 12 days, the textile structure was present, though the casing was slightly transparent and therefore the sausage emulsion was visible. The appearance was rated as slightly glossy—transparent textile sausage skin.

### EXAMPLE 2

A mixed woven fabric of 80% cotton and 20% polyester having a weight of 102 g/m² was enzymatically desized, foularded with a butyl aerylate emulsion polymer and coated with colored acrylic by doctorknife application. After a finishing application of a PVDC outer layer, drying and condensation, the textile thus coated had a total weight of 135 g/m². The open-width product was cut into strips having a width of 165 mm which were then formed to give tubes. The 9 mm overlapping longitudinal edges were glued with a reactive PUR hotmelt glue. The sausage casings produced in this manner were stuffed with cooked-meat sausage emulsion. They had a stuffing caliber of 52 mm. This produced fat-tight sausages having a textile optical appearance, the seam of which was elastic and fat-tight.

After a ripening and smoking time of 5 days, the appearance was rated as colorfast, matt and true to textile.

Additional advantages, features and modifications will readily occur to those skilled in the art. Therefore, the invention in its broader aspects is not limited to the specific details, and representative devices, shown and described herein. Accordingly, various modifications may be made without departing from the spirit or scope of the general inventive concept as defined bye the appended claims and their equivalents.

As used herein and in the following claims, articles such as “the”, “a” and “an” can connote the singular or plural.

All documents referred to herein are specifically incorporated herein by reference in their entireties.

We claim:

1. A tubular food casing comprising a coated flat support material having a glued longitudinal seam, wherein the seam, comprises a reactive hotmelt glue.

2. The food casing as claimed in claim 1, wherein the hotmelt glue cures under the action of moisture.

3. The food casing as claimed in claim 1, wherein the hotmelt glue is a one-component polyurethane-based hotmelt glue.

4. The food casing as claimed, in claim 1, wherein the flat support material is a woven fabric, loop-forming knitted fabric, loop-drawingly knitted fabric, laid fabric, consolidated nonwoven, spunbonded nonwoven or a fiber paper.

5. The food casing as claimed in claim 4, wherein the flat support material comprises natural fibers and/or synthetic fibers.

6. The food casing as claimed in claim 5, wherein the natural fibers are selected from cotton, linen, viscose staple, wool and/or silk, and the synthetic fibers are selected from polyester, polyamide, polyolefin, polyvinyl acetate), polyacrylonitrile, poly(vinyl chloride), or corresponding copolymers.

7. The food casing as claimed in claim 4, wherein the flat support material has a weight of 8 to 300 g/m².

8. The food casing as claimed in claim 4, wherein the flat support material is coated with an acrylic resin, collagen, or a protein derived therefrom.

9. The food casing as claimed in claim 1, wherein the food casing has a total weight in the dry state of 40 to 400 g/m².

10. The food casing as claimed in claim 4, wherein the flat support material is impregnated.

11. The food casing as claimed in claim 10, wherein the flat support material is impregnated with melamine/formaldehyde resin, hydroxypropylated starch ethers, copolymers having units of vinyl acetate, acrylic resins, or polyamine-polyamide-epichlorohydrin resins.

12. The food casing as claimed in claim 4, wherein the flat support material is colored with dyes and/or color pigments.

13. The food casing as claimed in claim 12, wherein a colored support material is combined with a non-colored coating.

14. The food casing as claimed in claim 4, wherein the textile support material is non-colored and is combined with a colored coating.

15. The food casing as claimed in claim 13, wherein the coating comprises (meth)acrylic polymers or copolymers, collagen and/or collagen derivatives.

16. The food as claimed in claim 14, wherein the coating comprises (meth)acrylic polymers, collagen and/or collagen derivatives.

17. The food casing as claimed in claim 1, wherein, on the inside and/or outside, the food casing further comprises at least one layer having barrier properties for oxygen and/or water vapor.

18. The food casing as claimed in claim 1, wherein, on the inside, the food casing further comprises an impregnation or coating and/or agents which comprise transferable color, aroma, odor and/or taste substances.

19. The food casing as claimed in claim 1, wherein the food casing further comprises an elastic or nonelastic net.

20. The food casing as claimed in claim 1, wherein the food casing is completely glued along the longitudinal seam so that no projecting edge remains.

21. The food as claimed in claim 1, wherein the food casing is finally processed into shirred sticks or sections closed at one end.

22. The food casing as claimed in claim 21, wherein the food casing is finally processed as a section and closed at one end by a clip, clip with loop, tie, knots, gluing, sealing, welding, stitching or a combinatoin of a plurality of said methods.

23. A process for producing a food casing as claimed in claim 1, which comprises the following steps in the stated sequence:
a) providing a flat fibrous material;
b) optionally removing a sizing material;
c) optionally treating the flat fibrous material with an impregnating agent;
d) optionally printing the flat fibrous material;
e) charging the whole surface of one or both sides of the flat fibrous material with coating comprising acrylic resin, collagen and/or a protein derived therefrom in one or more strokes;
f) optionally whole-surface charging of one or both sides of the coated flat fibrous material with barrier layer;
g) condensing the coating(s);
h) optionally cutting the coated whole-width flat fibrous material into strips;
i) optionally printing the strips;
j) forming the coated flat fibrous material or strips via a forming shoulder to give a tube having overlapping longitudinal edges;
k) gluing the overlapping region using a reactive hotmelt glue;
l) curing the glued seam at 25 to 75% relative humidity and 20 to 45° C. for 3 to 7 days;
m) optionally finally processing the food casing.

24. The process as claimed in claim 23, wherein the reactive hot melt glue is a reactive PUR hotmelt glue having a Brookfield viscosity of 3000 to 7000 mPa·s.

25. The process as claimed in claim 23, wherein the reactive hotmelt glue is applied as thin melt film to the longitudinal edge of the casing which after joining is on the lower side of the overlapping region

26. The process as claimed in claim 23, wherein the overlapping longitudinal edges form an overlapping region which is 2 to 14 mm wide.

27. The process as claimed in claim 26, wherein the overlapping region is 4 to 12 mm wide.

28. The process as claimed in claim 23, wherein the reactive hotmelt glue is a reactive PUR hotmelt glue.
